(19) United States
(12) Patent Application Publication
(10) Pub. No.: US 2019/0130077 A1
(43) Pub. Date: May 2, 2019

(54) SENSOR SYSTEM AND METHOD FOR COGNITIVE HEALTH ASSESSMENT

(71) Applicant: The Curators of the University of Missouri, Columbia, MO (US)

(72) Inventors: Debraj De, Rolla, MO (US); Sajal K. Das, Rolla, MO (US); Mignon Makos, Rolla, MO (US)

(73) Assignee: The Curators of the University of Missouri, Columbia, MO (US)

(21) Appl. No.: 15/801,026

(22) Filed: Nov. 1, 2017

(51) Int. Cl. G06F 19/00

(52) U.S. Cl. CPC G06F 19/3431; G06F 19/363

(57) ABSTRACT

Sensors arranged on a chair on which a subject is seated detect a physical characteristic of the subject during administration of a cognitive health assessment. An assessment processor coupled to the sensors executes computer-executable instructions causing the processor to determine a contemporaneous reaction corresponding to each of the questions as a function of the detected physical characteristic. And the subject is assigned a cognitive health assessment score based on the subject's answers and determined reactions.

### STATEMENT REGARDING FEDERALLY SPONSORED RESEARCH OR DEVELOPMENT

This invention was made with government support under grants NSF 1648907, NSF 1540119, and NSF 1404673 awarded by the National Science Foundation. The government has certain rights in the invention.

### TECHNICAL FIELD

Aspects of the present disclosure generally relate to sensors for use with a cognitive health assessment. Specifically, aspects of the present disclosure relate to pressure sensors arranged on a chair for tracking fine-grained bodily movements of a subject (representative of human stress and emotional level) seated in the chair while undergoing a cognitive health assessment or screening test.

### BACKGROUND

According to the U.S. Department of Health and Human Services (HHS), cognitive health refers to a person's ability to clearly think, learn, and remember. As such, it is critically important to brain health and maintaining the brain-based skills needed to carry out tasks for independent living. Conventional cognitive assessment and screening tools help identify individuals who may need additional evaluation, and who are possibly at risk of dementia, delirium, functional decline, or other cognitive impairment. Those skilled in the art recognize that early identification of cognitive changes provides an opportunity for case finding, crisis avoidance, and identification of subjects for earlier intervention and management, including a discussion of goals with the subject, and assurance that advance directives are complete and accurate.

A number of testing methods and tools are available for cognitive health assessment/screening in a clinical setting, such as a patient's doctor visit or regular check-up. The U.S. national Alzheimer's Association, for example, provides guidelines and tools for conducting a cognitive assessment, during a time-limited office visit at a doctor's office, hospital, or clinic. These cognitive screening tools usually consist of questionnaires administered by healthcare professionals. The subject answers a question orally or in writing, with each answer being assigned a certain number of points. Different questions in the cognitive screening test assess different aspects of cognitive health, such as orientation, memory, recall, attention, vigilance, repetition, verbal fluency, abstraction, etc. Popular cognitive assessments include: Mini-Mental State Exam (MMSE), Modified Mini-Mental State Exam (3MS), Mini-Cog, Montreal Cognitive Assessment (MoCA), Saint Louis University Mental Status (SLUMS), General Practitioner Assessment of Cognition (GPCOG), and Memory Impairment Screen (MIS).

Unfortunately, conventional assessments are burdensome to healthcare professionals administering the screenings and provide only rudimentary results without accounting for fine-grained, non-verbal distinctions in patient responses.

### SUMMARY

Aspects of the disclosure relate to a chair-based sensor system for identifying a patient's stress during administration of a cognitive health assessment and correlating the stress to the subject's answers for providing an improved assessment.

In an aspect, a system comprises one or more reaction sensors for detecting a physical characteristic of a subject during administration of a cognitive health assessment to the subject and an assessment processor coupled to the sensors. The system also comprises a computer-readable memory device coupled to the processor and storing one or more processor-executable instructions thereon. When executed by the processor, the processor-executable instructions cause the processor to determine a contemporaneous reaction corresponding to each of a plurality of health assessment questions as a function of the detected characteristic. And the subject is assigned a cognitive health assessment score based on the subject's answers and determined reactions.

A method embodying aspects of the invention comprises measuring a physical characteristic of a subject during administration of a cognitive health assessment to the subject and determining a contemporaneous reaction to each of a plurality of cognitive health questions by the subject as a function of the detected characteristic. The method further comprises measuring time delay between administration of at least one of the questions and an answer to the respective question from the subject, correlating the determined reaction and the time delay, and assigning a cognitive health assessment score to the subject based on the answer from the subject, the determined reaction, and the time delay for each of the questions.

In another aspect, a system comprises a plurality of sensors arranged on a chair on which a subject is seated for detecting a physical characteristic of the subject during administration of a cognitive health assessment to the subject. The system further includes an assessment processor coupled to the sensors and a computer-readable memory device coupled to the processor. The memory stores processor-executable instructions that, when executed, cause the processor to determine a contemporaneous reaction corresponding to each of the questions as a function of the detected characteristic. And the subject is assigned a cognitive health assessment score based on the subject's answers and determined reaction.

Other objects and features will be in part apparent and in part pointed out hereinafter.

### BRIEF DESCRIPTION OF THE DRAWINGS

FIG. 1 is a block diagram illustrating an exemplary system including chair-based sensors according to an embodiment.

FIG. 2 is a block diagram illustrating a communications board of the system of FIG. 1.

FIGS. 3A to 3F are schematic diagrams illustrating an exemplary circuit implementation of the communications board of FIG. 2.

FIGS. 4A and 4B are examples of a subject's pre- and post-medication response data obtained using the system of FIG. 1.

FIGS. 5A and 5B are examples of another subject's pre- and post-medication response data obtained using the system of FIG. 1.

FIGS. 6 to 8 are examples of different subject's response data obtained using the system of FIG. 1 during administration of a cognitive health questionnaire.

FIGS. 9 to 12 are examples of response data obtained using the system of FIG. 1 during administration of a cognitive health questionnaire showing correlations between the response data and the questionnaire.

FIG. 13 is an exemplary diagram illustrating cognitive health scoring according to an embodiment.

FIG. 14 is an exemplary flow diagram further illustrating cognitive health scoring according to the embodiment of FIG. 13.

Corresponding reference characters indicate corresponding parts throughout the drawings.

### DETAILED DESCRIPTION

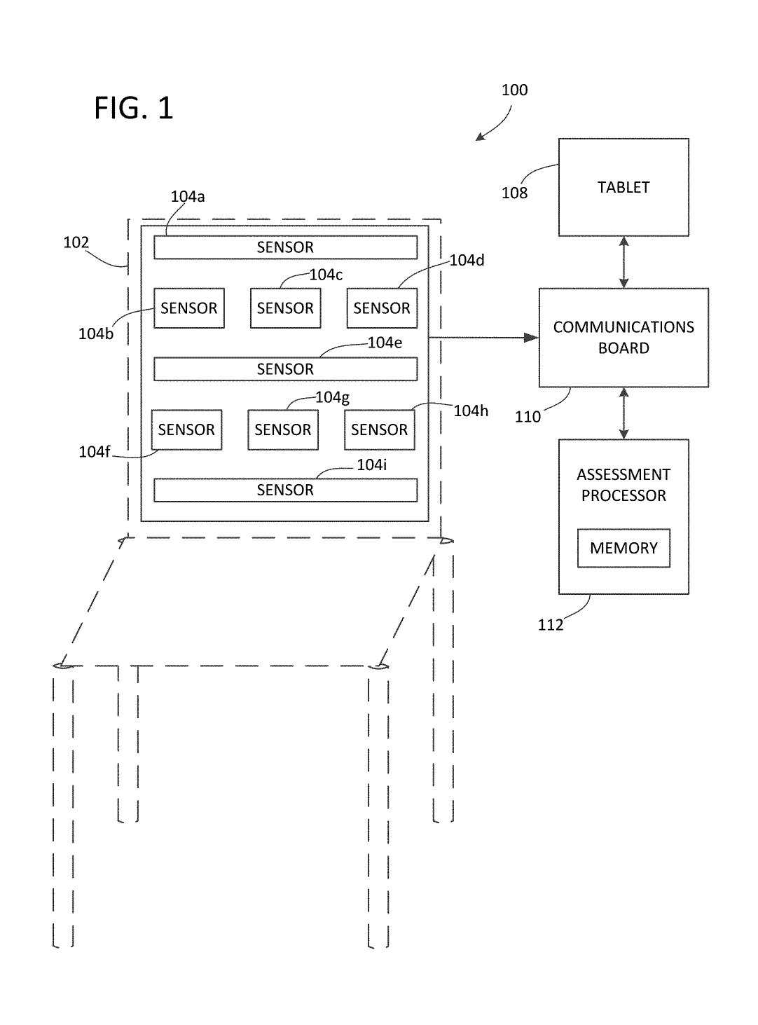

Referring to FIG. 1, a chair-based sensor system 100 provides a more advanced and accurate cognitive assessment/screening in accordance with embodiments of the invention. In use, when a patient or other person of interest (generally referred to here as a “patient” or “subject”) comes to a cognitive screening session, the subject sits on a “smart” chair 102 having a plurality of reaction sensors 104. As shown in FIG. 1, the individual sensors 104 are referenced as 104a to 104i. It is to be understood that different numbers and arrangements of sensors could be used without deviating from the scope of the invention.

In an embodiment, the chair 102 comprises a regular chair having an array of sensors 104 draped over its back rest or otherwise arranged such that the subject's back is in contact with sensors 104 when the subject is seated. While seated, the subject answers a standardized set of cognitive screening questions (e.g., SLUMS test). Preferably, the subject enters his or her answers directly via the user interface of a tablet 108. Although illustrated and described herein as tablet, it is to be understood that embodiments of the invention could be implemented with other types of computing devices, such as a laptop computer, smartphone or the like. In another embodiment, a healthcare professional administering the tests enters the subject's answers via the tablet 108. Aspects of the invention involve tracking in real-time the subject's time delay in answering each question from the questionnaire. Moreover, sensors 104 measure the subject's non-verbal psycho-physical/psychological-physical stress and behavior reaction resulting from each question. A communications board 110 associated with sensors 104 collects the sensor data for transmission to an assessment processor 112 (e.g., a computer/receiver base station) along with the questionnaire answers. In an embodiment, tablet 108 and process 112 are embodied by the same computing device.

According to aspects of the invention, reaction sensors 104 measure a contemporaneous reaction to each of the questions by the subject as a function of a detected physical characteristic, such as changes in pressure exerted by the subject on the chair indicating fine-grained movements. The detected physical characteristics are indicative of a biometric response to stimuli, whether physiological or behavioral in origin. It is to be understood that reactions could be indicated by changes in physical characteristics other than pressure. In an embodiment, sensors 104 comprise one or more pressure sensors for detecting changes in pressure exerted by the subject on the sensors. In an alternative embodiment, sensors 104 comprise a wearable device having one or more sensors for detecting one or more of the subject's pulse rate, temperature, galvanic skin response, temperature, movement, etc. In yet another embodiment, sensors 104 comprise one or more imaging sensors of a camera, for example, for collecting image data representative of the subject's facial expression, skin temperature, and/or the like. And in yet another embodiment, sensors 104 comprise one or more electroencephalography (EEG) sensors in a headset, for example, for detecting the subject's EEG response.

The processor 112 correlates the smart chair's sensor data streams to the answers from the questionnaire and executes a cognitive health scoring algorithm that integrates the information and intelligence about the subject's indirect reactions with the subject's direct responses. In this manner, aspects of the invention reduce the assessment burden of healthcare professionals and accounts for fine-grained, subtle distinctions in patient responses resulting from the subject's stress, emotion, comfort, attention, etc. while responding to the questionnaire.

Instead of scoring the cognitive health performance solely from accuracy of the questionnaire, the chair-based system 100, including sensors 104 embedded in a smart chair cover and the tablet/phone app based cognitive questionnaire, captures the subject's non-verbal reaction (related to stress, emotion, comfort, attention, etc.) and then processor 112 executes a proprietary algorithm to contextually integrate the quantified non-verbal reaction and direct answer-based score response together, to generate a final, novel cognitive health scoring system.

Aspects of the cognitive screening system and scoring mechanism provide advances in cognitive health assessment effectiveness and accuracy. This includes: (i) being able to distinguish delirium from dementia; (ii) identifying different types of dementia; (iii) distinguishing mild cognitive impairment from early dementia; and (iv) predicting other comorbidities.

In an embodiment, the cognitive questionnaire presented via tablet 108 has direct audio play options for playing the sound of asking questions. This standardization of asking questions through fixed audio removes the burden of numerous and repetitive test sessions on the healthcare professionals (i.e., the cognitive screening test administrators), supports audio in a plurality of languages, thus eliminating the need to make available test administrators who speak different languages, and provides more uniform testing. In other words, aspects of the invention minimize manual and repetitive efforts of test administrators.

Existing cognitive health assessment methods cannot capture how a subject responds non-verbally to a questionnaire. This non-verbal patient reaction, such as comfort, agitation, attention, engagement, or the like contains valuable information that can indicate cognitive health status more accurately and in a more fine-grained manner (such as more than merely low/medium/high dementia levels) and can even predict cognitive health status and comorbidities in advance. In an embodiment, sensors 104 comprise an array of pressure sensors or force sensitive resistors embedded on a chair cover and positioned on the back rest of chair 102. These sensors 104 capture the subject's subtle physical movements while answering the standard cognitive questions. It is to be understood that system 100 could also be used in connection with other mental health apps (e.g., the PTSD Coach app available from the U.S. Department of Veterans Affairs) instead of or in addition to cognitive health assessment questionnaires.

Referring further to the embodiment illustrated in FIG. 1, system 100 embeds nine pressure sensors 104 in an array on the back rest of chair 102. In another embodiment, system 100 includes an array of pressure sensors 104 on a sleeve covering the back rest. It is to be understood that sensors 104 could be arranged on the seat of chair 102 instead of or in addition to the back rest of chair 102. The communications board 110 collects the sensor data and transmits it wirelessly (e.g., via a near field communications protocol such as Bluetooth) to processor 112. As described above, processor 112 embodying a receiver/base station may be implemented in a laptop computer, tablet, smartphone, or the like (using its own Bluetooth receiver). The processor 112 collects the live streams of sensor data for analysis in accordance with a custom-designed machine learning based algorithm for generating an enhanced cognitive health score (which is different than simply the score based on answers to the questionnaire). Assessment processor 112 determines, from each of sensors 104, a contemporaneous reaction to each of the questions by the subject as a function of a detected physical characteristic, such as changes in pressure exerted by the subject on the chair indicating fine-grained movements. In an embodiment, a quantified value representing the detected reaction below a predetermined threshold indicates substantially no stress exhibited by the subject during the question while a quantified value representing the detected reaction above the predetermined threshold indicates stress exhibited by the subject during the question.

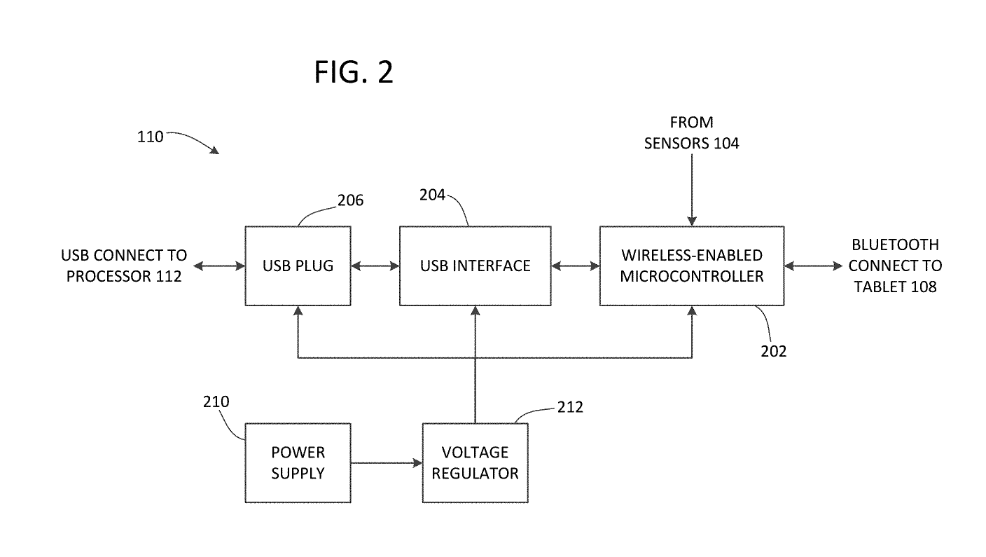

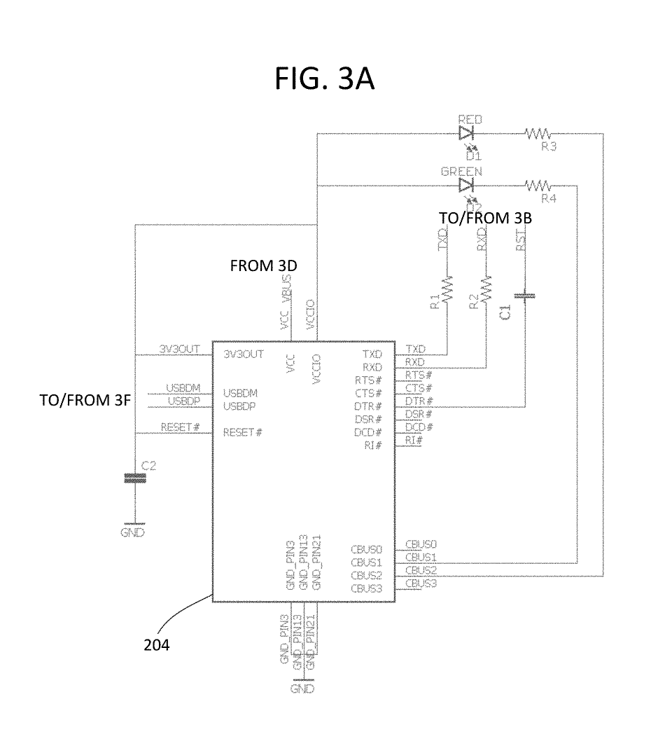

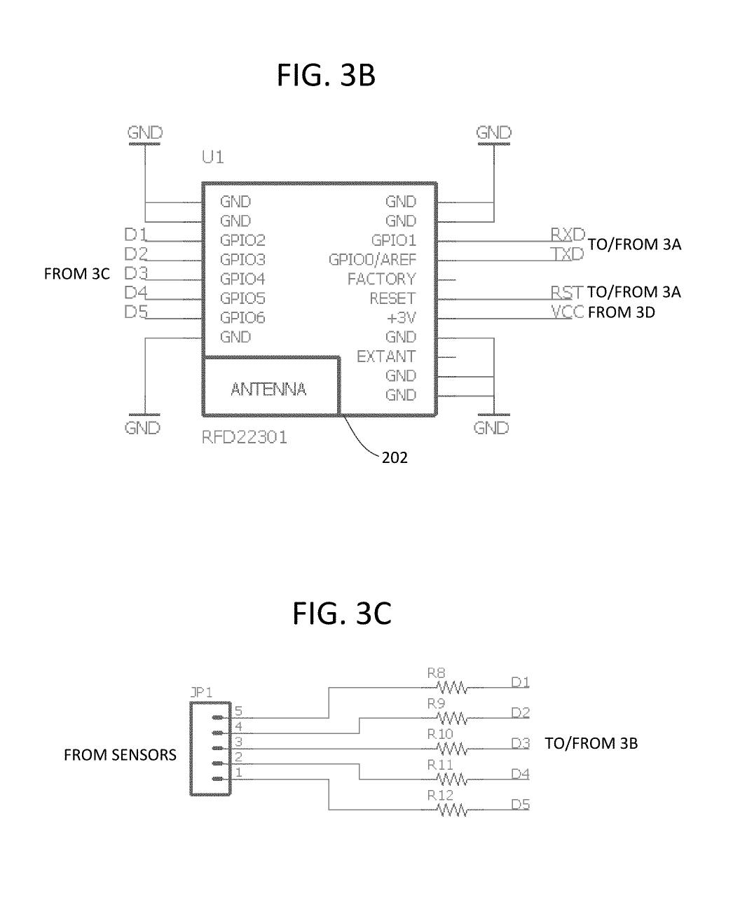

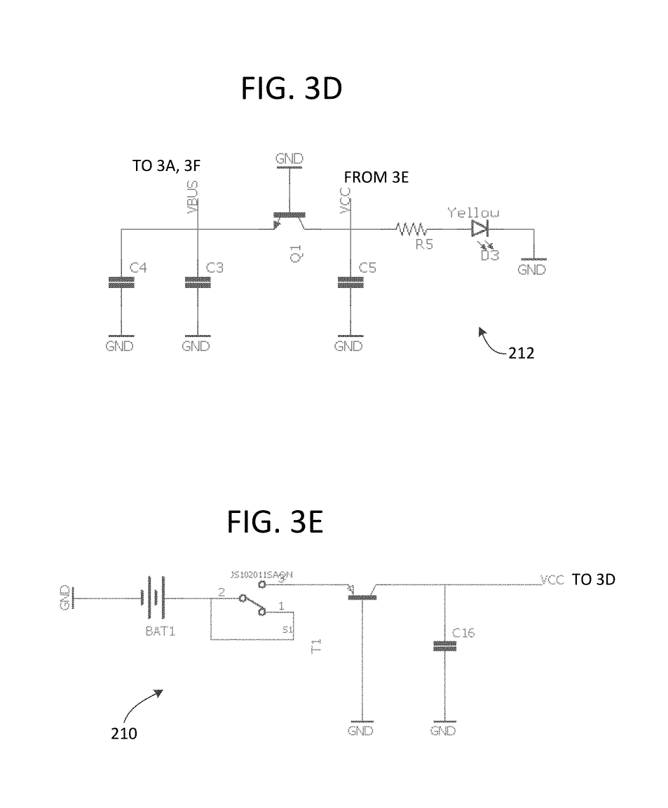

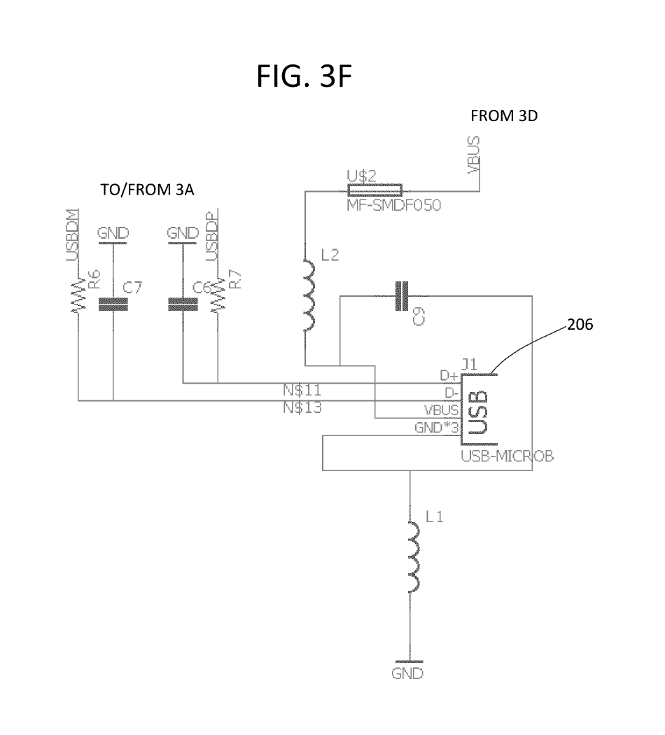

FIG. 2 is a block diagram illustrating the communications board 110 of system 100. In an embodiment, board 110 has its own processor, serial peripheral interface (SPI) bus and inter-integrated circuit (I²C) bus to read sensor data, memory, Bluetooth wireless radio, and battery support. FIGS. 3A to 3F are schematic diagrams illustrating an exemplary circuit implementation of board 110.

As shown in FIG. 2, the communications board 110 of system 100 includes a wireless enabled microcontroller 202 configured to read sensor data on input/output pins, perform processing/computation, and send data wirelessly through low-power Bluetooth communication. In an embodiment, RFD22301 available from RFDigital Corporation and shown in FIG. 3B is a suitable microcontroller 202. FIG. 3C illustrates a sensor plug for providing the signals from sensors 104 to the microcontroller 202. FIG. 3C further illustrates resistors R8-R12 to control flow of current to other components of board 110.

FIG. 2 further illustrates a USB interface 204 in communication with microcontroller 202. The USB interface 204 provides a USB to serial universal asynchronous receiver/transmitter (UART) communication interface having full modem control. In an embodiment, FT231X available from Future Technology Devices International and shown in FIG. 3A is a suitable USB interface 204. FIG. 3A further illustrates red and green LEDs for visually indicating certain operations being done by USB interface 204 (e.g., USB communication's send and receive, processor reprogramming), capacitors C1 and C2 to help stabilize the power supply, and resistors R1, R2, R3, and R4 to control flow of current to other components of board 110.

Referring further to FIG. 2, a USB plug 206 permits connections between processor 112 and microcontroller 202 via the USB communications interface 204. In an embodiment, the USB plug 206 is a USB micro USB SMD connector used for USB communication as shown in FIG. 3F. FIG. 3F further illustrates capacitors C6, C7, and C9 to help stabilize the power supply, resistors R6 and R7 to control flow of current to other components of board 110, a fuse U$2 for protection against overcurrent faults in the electronic circuitry, and ferrite beads L1 and L2 for passive suppression of high frequency noise in the electronic circuitry.

A power supply 210 supplies power to microcontroller 202, USB interface 204, and USB plug 206 via a voltage regulator 212. FIG. 3E illustrates an exemplary schematic diagram of a power circuit suitable for use as the power supply 210. As shown, power supply 210 in this embodiment includes a battery (e.g., a coin cell battery) connected via a switch for manually powering the board 110 ON and OFF to a MOSFET charging circuit. A capacitor C16 helps stabilize the power supply. FIG. 3D illustrates an embodiment of the voltage regulator 212. In this figure, a transistor Q1 regulates the voltage to maintain a constant voltage level at the USB, a yellow LED visually indicates certain operations being done by USB interface 204 (e.g., USB communication's send and receive, processor reprogramming), capacitors C3-C5 help stabilize the power supply, and a resistors R5 controls flow of current to other components of board 110.

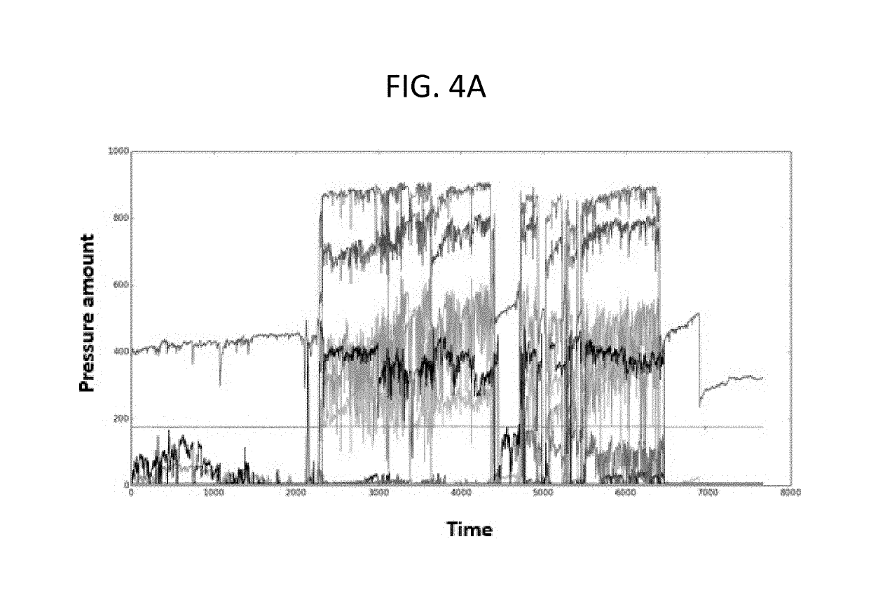

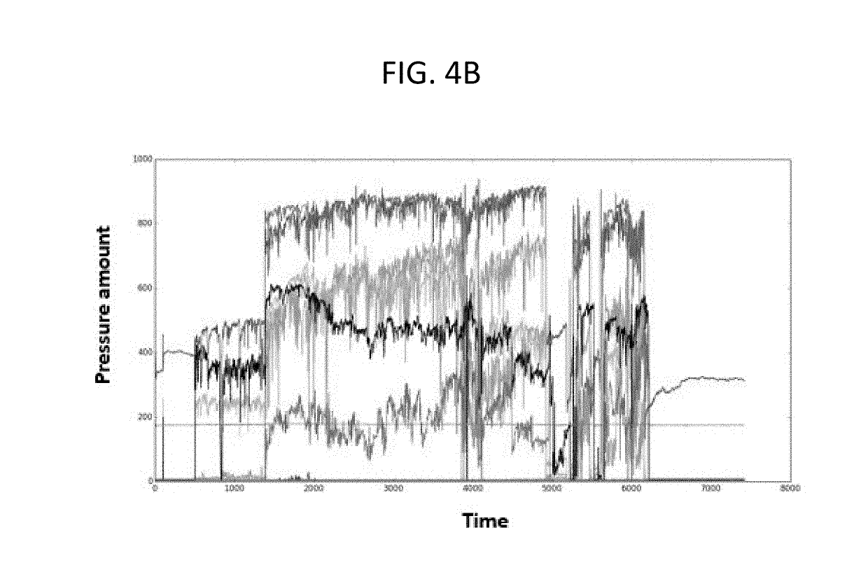

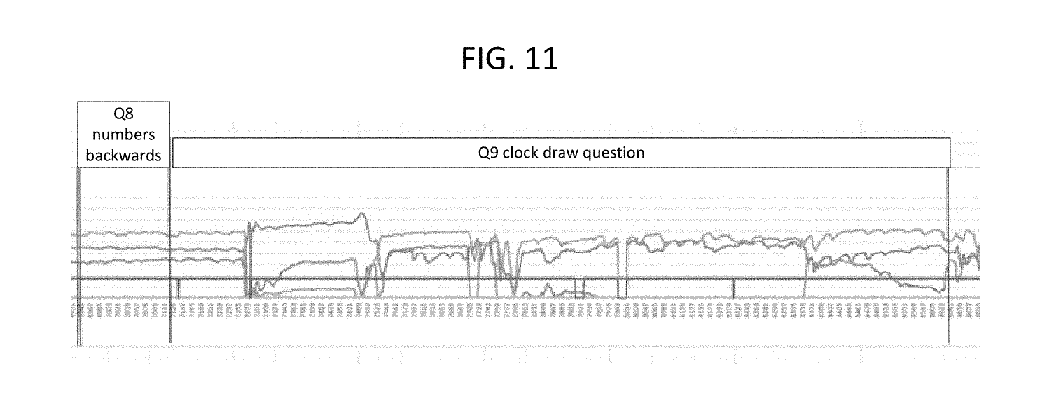

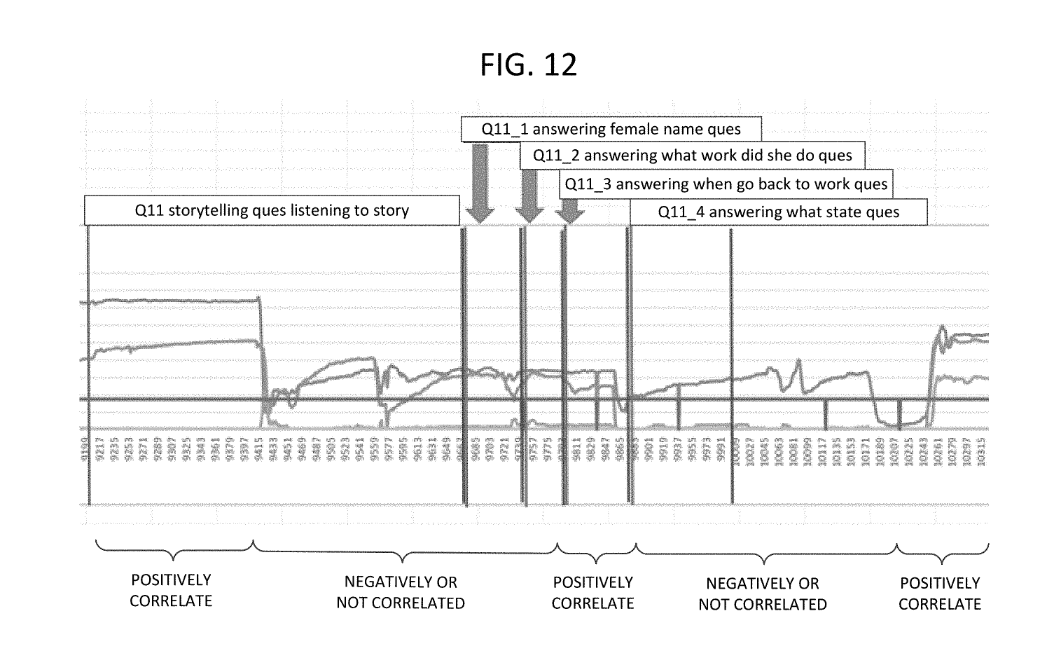

FIGS. 4A, 4B, 5A, 5B, 6-8, and 9-12 are examples of patient non-verbal response datasets acquired by system 100 during administration of SLUMS cognitive screening/assessment test sessions or comparable standardized questionnaires. The SLUMS screening questionnaire consists of 11 brief questions scored on a 30 point scale and takes approximately seven to 10 minutes to administer. Questions cover a wide range of functions, including memory, attention, orientation, and overall executive function. This includes everything from clock drawing to animal naming as well as tests on digit span, size differentiation, and figure recognition.

FIG. 4A is an example of patient response data from sensors 104 during answering to a SLUMS test cognitive questionnaire. In this instance, the subject was a middle aged working female with occasional mental health issues, such as talking to herself sometimes in workplace. The test was administered before medication and yielded a SLUMS score of 24/30.

FIG. 4B is an example of patient response data from sensors 104 for the same subject as FIG. 4A. The test was administered after medication and yielded a SLUMS score of 27/30. Note: the subject was observed to be more energetic and prompt after taking medication for attention.

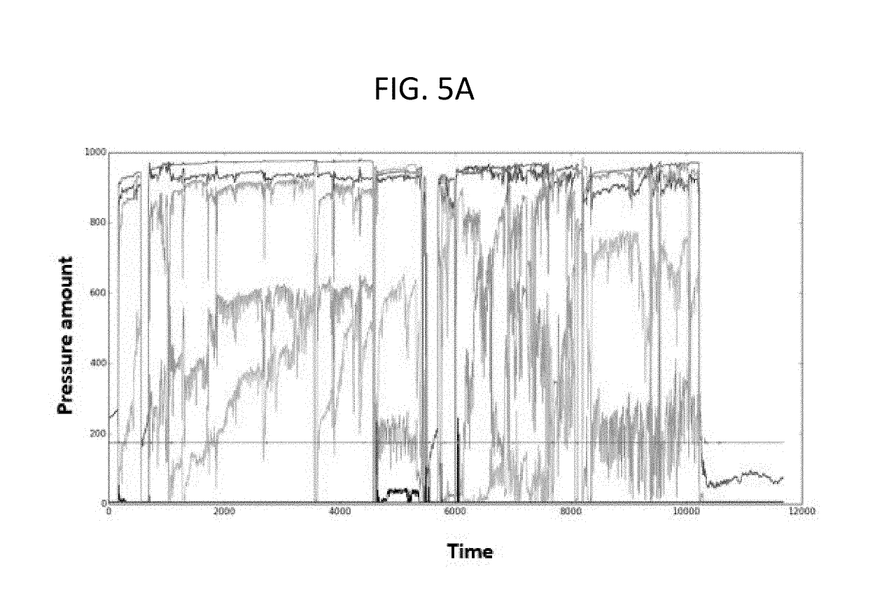

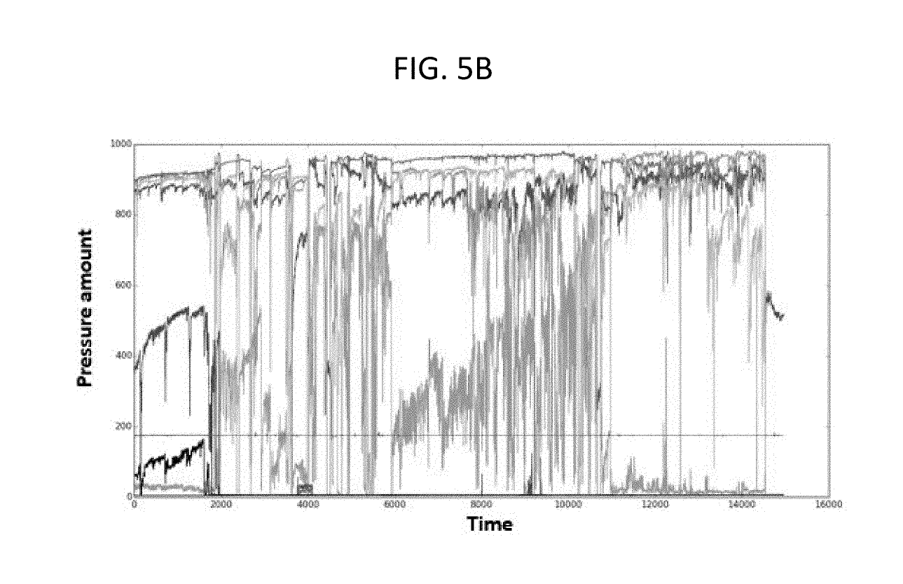

FIG. 5A is an example of patient response data from sensors 104 during answering to a SLUMS test cognitive questionnaire. In this instance, the subject was an elderly male, retired person, who volunteers in church and hospital settings. The test was administered before medication and yielded a SLUMS score of 24/30.

FIG. 5B is an example of patient response data from sensors 104 for the same subject as FIG. 5A. The test was administered after medication and yielded a SLUMS score of 27/30. Note: the subject was observed to be more conversational in this session but overall he was talking in both sessions (before and after medication for attention).

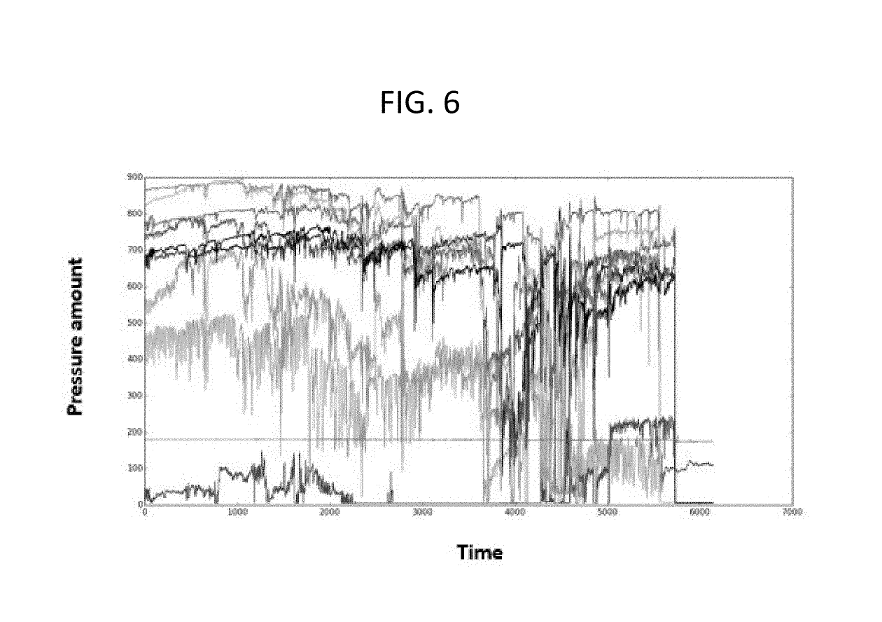

FIG. 6 is an example of patient response data from sensors 104 during answering to a SLUMS test cognitive questionnaire. In this instance, the subject was an elderly female, retired person and the test yielded a SLUMS score of 26/30.

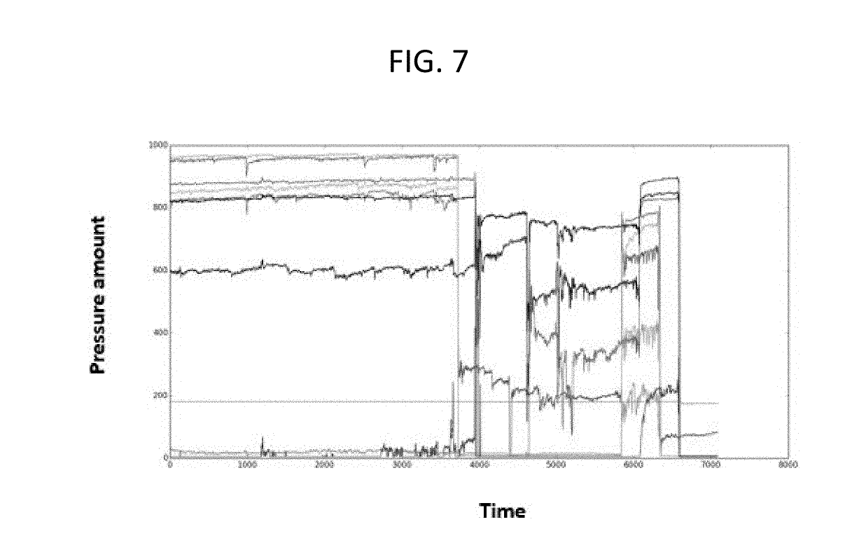

FIG. 7 is an example of patient response data from sensors 104 during answering to a SLUMS test cognitive questionnaire. In this instance, the subject was a middle aged male having brain frontal lobe damage due to conditions and incidents and the test yielded a SLUMS score of 20/30. Note: the subject was observed to exhibit static non-verbal response on the back rest of chair 102. The data pattern is very flat and no significant change was observed in pressure sensors data during the entire session, only some variations towards the second half of the session (but still very low rate of changes in sensor data compared to other patients as in above figures).

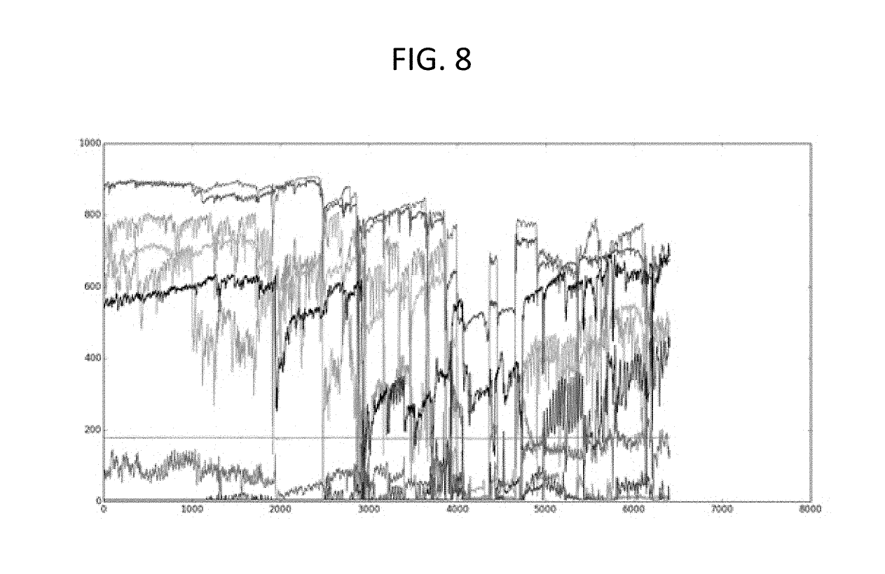

FIG. 8 is an example of patient response data from sensors 104 during answering to a SLUMS test cognitive questionnaire. In this instance, the subject was an elderly male diagnosed with ALS (Amyotrophic Lateral Sclerosis) and the test yielded a SLUMS score of 23/30.

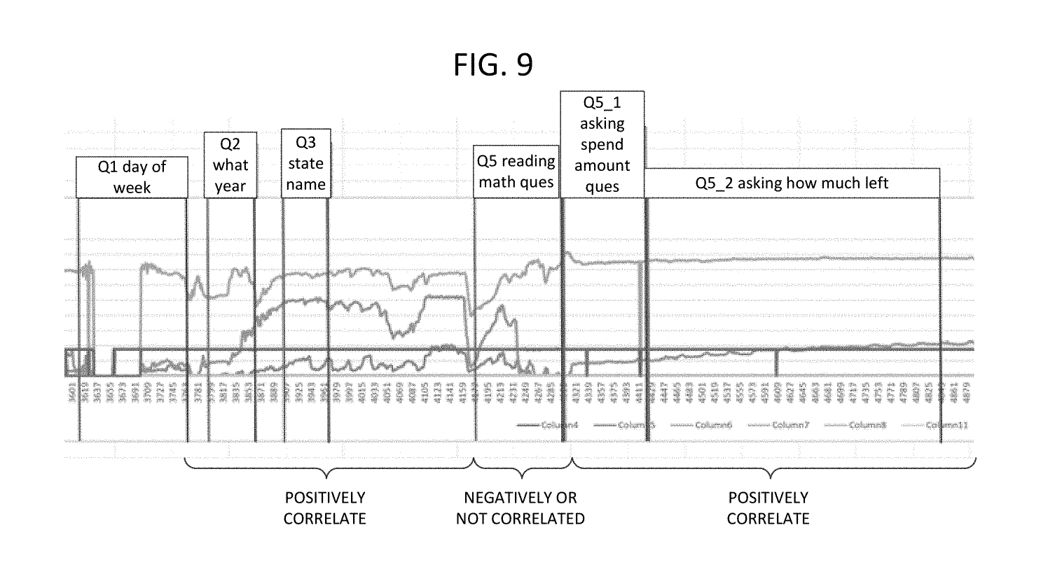

FIGS. 9-12 provide a more detailed analysis of one sample patient non-verbal reaction from sensors 104, during answering a SLUMS test questionnaire. Each figure level contains details of patient description and observation. In addition to assessing the answers to the SLUMS cognitive test standardized questionnaire, aspects of the invention track the time between asking the questions. Correlations indicated in these figures are among multiple active pressure sensor data, for example.

FIG. 9 shows pressure sensors data from sensors 104 illustrated during some specific questions in a SLUMS cognitive test. It was observed that sensors data are positively correlated when the subject is comfortable, and less or negatively correlated when the subject is less comfortable or stressed (e.g., during a difficult question in test). The response data captures patient stress or emotion related non-verbal response from sensors 104.

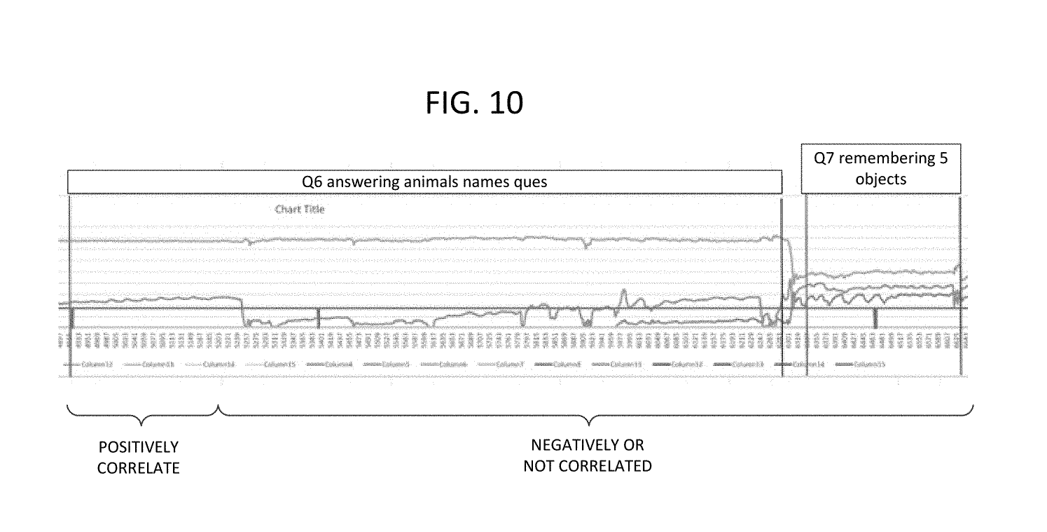

FIGS. 10-12 show pressure sensors data from sensors 104 illustrated during some specific questions in a SLUMS cognitive test.

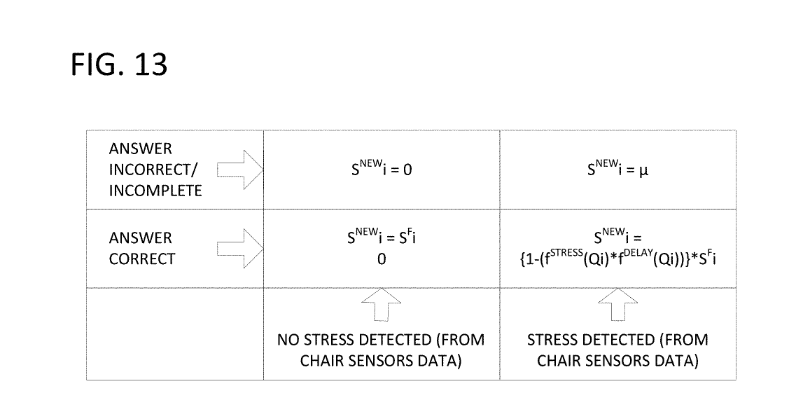

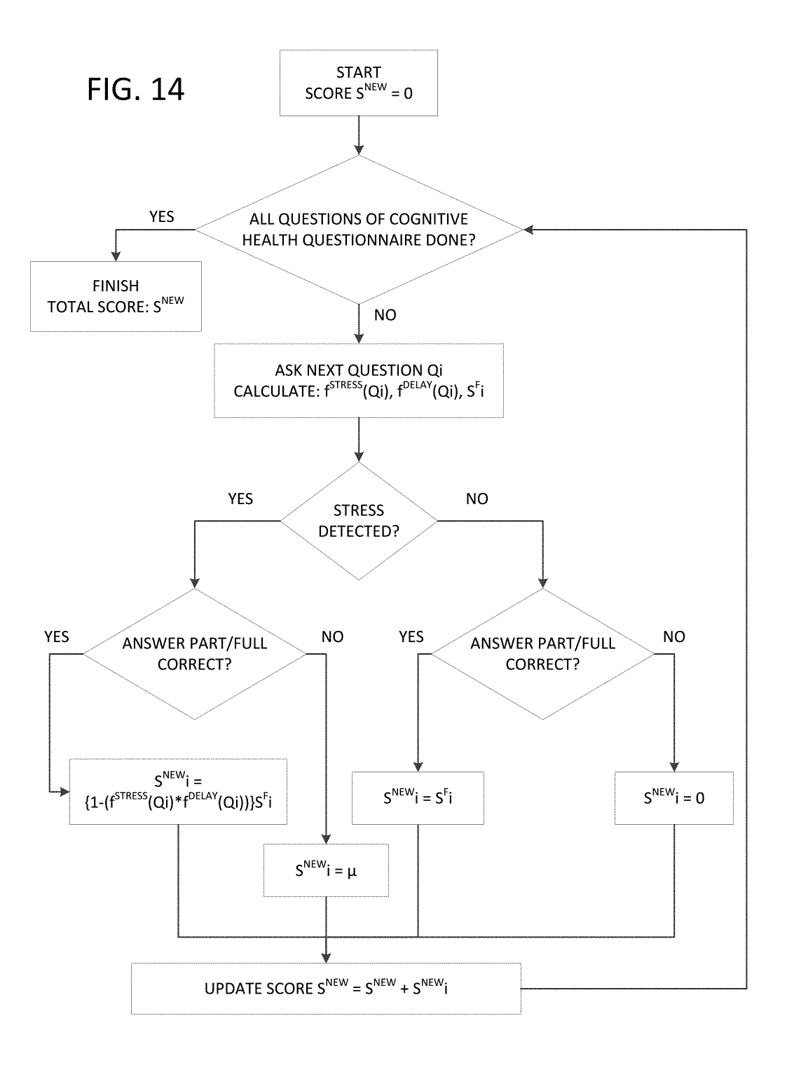

FIGS. 13 and 14 are exemplary flow diagrams illustrating aspects of cognitive health scoring that integrates a patient's mood/ emotional response during the cognitive screening test. In other words, assessment processor 112 executes computer-executable instructions to determine a score integrating patient non-verbal, not-visible emotional (e.g., mood and/or stress) response data obtained via chair sensors 104 during cognitive screening. Advantageously, system 100 integrates the patient's mood/stress profile (converted to a quantified value) during each question response without requiring a separate, additional/stress evaluation.

As shown in FIG. 13, an exemplary cognitive health scoring algorithm embodies aspects of the invention. The cognitive screening has N questions Q₁, Q₂, . . . , O_{N}. Now each question Qᵢhas a full score value S^{F}ᵢ and patient obtained actual score value S^{A}ᵢ (based on correctness of answer to each question). Conventional cognitive screening methods compute a complete performance score SA as: SA=^{A}₁+S^{A}₂+ . . . +S^{A}=Σᵢ₌₁^{N}S^{A}ᵢ in the scale of full score of SF=^{F}₁+S^{F}₂+ . . . +S^{F}_{N}=Σᵢ₌₁^{N}S^{F}ᵢ. In this embodiment, cognitive health scoring includes:

Full score: SF=^{F}₁+S^{F}₂+ . . . +S^{F}_{N}=Σᵢ₌₁^{N}S^{F}ᵢ

State-of-the-art clinical cognitive scoring system: SA=^{A}₁+S^{A}₂+ . . . +S^{A}_{N}=Σᵢ₌₁^{N}S^{A}ᵢ

Cognitive scoring system: S^{New}=S^{New}₁+S^{New}₂+ . . . +S^{New}_{N}=Σᵢ₌₁^{N}S^{New} ᵢ

According to aspects of the present disclosure, when a patient answers question Qᵢ correctly and chair sensors 104 detect non-verbal reaction data indicative of substantially no stress, then the score associated with the particular question is assigned a score S^{New}ᵢ as the full score of the question, S^{F}ᵢ. But if the answer is correct but chair sensors 104 detect non-verbal, physical response data indicative of stress, the score associated with the particular question is assigned a reduced score S^{New}ᵢ={1−(f^{stress}(Qᵢ)*f^{delay}(Qᵢ))}*S^{F}ᵢ. The reduction factor is a function of amount of both stress detected and delay in answering the question. In this embodiment, even if the patient answered correctly, detection of stress indicates some degree of cognitive difficulty and impairment. Thus the score is reduced for question Qᵢ.

Referring further to FIG. 13, when the patient answers incorrectly or incompletely and chair detects substantially no stress, then assessment processor 112 assigns a zero value for the score S^{New}ᵢ associated with the particular question. But when the answer is incorrect or incomplete and chair sensors 104 detect non-verbal physical characteristics data indicative of stress, the score S^{New}ᵢ associated with the particular question is assigned a non-zero low bonus score of μ. The rationale in this case is that a patient experiencing severe dementia would not feel uncomfortable when giving a wrong answer, because they believe the wrong answer to be correct (for example, thinking and believing that the day is Tuesday even if it is actually Friday). Thus, patients showing some amount of stress/discomfort when answering incorrect, get a low score of μ (instead of a 0).

These strategies help distinguish mild cognitive impairment in a patient from more serious early dementia (the later can develop into Alzheimer's disease, which is too late for certain treatments).

FIG. 14 is an exemplary flow diagram further illustrating cognitive health scoring according to the embodiment of FIG. 13.

In addition to the embodiments described above, embodiments of the present disclosure may comprise a special purpose computer including a variety of computer hardware, as described in greater detail below.

Embodiments within the scope of the present disclosure also include computer-readable media for carrying or having computer-executable instructions or data structures stored thereon. Such computer-readable media can be any available media that can be accessed by a special purpose computer and comprises computer storage media and communication media. By way of example, and not limitation, computer storage media include both volatile and nonvolatile, removable and non-removable media implemented in any method or technology for storage of information such as computer readable instructions, data structures, program modules or other data. Computer storage media are non-transitory and include, but are not limited to, random access memory (RAM), read only memory (ROM), electrically erasable programmable ROM (EEPROM), compact disk ROM (CD-ROM), digital versatile disks (DVD), or other optical disk storage, solid state drives (SSDs), magnetic cassettes, magnetic tape, magnetic disk storage, or other magnetic storage devices, or any other medium that can be used to carry or store desired non-transitory information in the form of computer-executable instructions or data structures and that can be accessed by a computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which aspects of the disclosure may be implemented. Although not required, aspects of the disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that aspects of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing aspects of the disclosure includes a special purpose computing device in the form of a conventional computer, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory computer storage media, including nonvolatile and volatile memory types. A basic input/output system (BIOS), containing the basic routines that help transfer information between elements within the computer, such as during start-up, may be stored in ROM. Further, the computer may include any device (e.g., computer, laptop, tablet, PDA, cell phone, mobile phone, a smart television, and the like) that is capable of receiving or transmitting an IP address wirelessly to or from the internet.

The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The magnetic hard disk drive, magnetic disk drive, and optical disk drive are connected to the system bus by a hard disk drive interface, a magnetic disk drive-interface, and an optical drive interface, respectively. The drives and their associated computer-readable media provide nonvolatile storage of computer-executable instructions, data structures, program modules, and other data for the computer. Although the exemplary environment described herein employs a magnetic hard disk, a removable magnetic disk, and a removable optical disk, other types of computer readable media for storing data can be used, including magnetic cassettes, flash memory cards, digital video disks, Bernoulli cartridges, RAMs, ROMs, SSDs, and the like.

Communication media typically embody computer readable instructions, data structures, program modules or other data in a modulated data signal such as a carrier wave or other transport mechanism and includes any information delivery media.

Program code means comprising one or more program modules may be stored on the hard disk, magnetic disk, optical disk, ROM, and/or RAM, including an operating system, one or more application programs, other program modules, and program data. A user may enter commands and information into the computer through a keyboard, pointing device, or other input device, such as a microphone, joy stick, game pad, satellite dish, scanner, or the like. These and other input devices are often connected to the processing unit through a serial port interface coupled to the system bus. Alternatively, the input devices may be connected by other interfaces, such as a parallel port, a game port, or a universal serial bus (USB). A monitor or another display device is also connected to the system bus via an interface, such as video adapter. In addition to the monitor, personal computers typically include other peripheral output devices (not shown), such as speakers and printers.

One or more aspects of the disclosure may be embodied in computer-executable instructions (i.e., software), routines, or functions stored in system memory or nonvolatile memory as application programs, program modules, and/or program data. The software may alternatively be stored remotely, such as on a remote computer with remote application programs. Generally, program modules include routines, programs, objects, components, data structures, etc. that perform particular tasks or implement particular abstract data types when executed by a processor in a computer or other device. The computer executable instructions may be stored on one or more tangible, non-transitory computer readable media (e.g., hard disk, optical disk, removable storage media, solid state memory, RAM, etc.) and executed by one or more processors or other devices. As will be appreciated by one of skill in the art, the functionality of the program modules may be combined or distributed as desired in various embodiments. In addition, the functionality may be embodied in whole or in part in firmware or hardware equivalents such as integrated circuits, application specific integrated circuits, field programmable gate arrays (FPGA), and the like.

The computer may operate in a networked environment using logical connections to one or more remote computers. The remote computers may each be another personal computer, a tablet, a PDA, a server, a router, a network PC, a peer device, or other common network node, and typically include many or all of the elements described above relative to the computer. The logical connections include a local area network (LAN) and a wide area network (WAN) that are presented here by way of example and not limitation. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections shown are exemplary and other means of establishing communications over wide area network may be used.

Preferably, computer-executable instructions are stored in a memory, such as the hard disk drive, and executed by the computer. Advantageously, the computer processor has the capability to perform all operations (e.g., execute computer-executable instructions) in real-time.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the disclosure.

Embodiments may be implemented with computer-executable instructions. The computer-executable instructions may be organized into one or more computer-executable components or modules. Aspects of the disclosure may be implemented with any number and organization of such components or modules. For example, aspects of the disclosure are not limited to the specific computer-executable instructions or the specific components or modules illustrated in the figures and described herein. Other embodiments may include different computer-executable instructions or components having more or less functionality than illustrated and described herein.

When introducing elements of aspects of the disclosure or the embodiments thereof, the articles “a”, “an”, “the” and “said” are intended to mean that there are one or more of the elements. The terms “comprising”, “including”, and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
one or more reaction sensors for detecting a physical characteristic of a subject during administration of a cognitive health assessment to the subject, said cognitive health assessment including a series of questions to be answered by the subject;
an assessment processor coupled to the sensors; and
a computer-readable memory device coupled to the processor and storing one or more processor-executable instructions thereon, said processor-executable instructions, when executed by the processor, causing the processor to determine a contemporaneous reaction corresponding to each of the questions as a function of the detected physical characteristic, wherein the subject is assigned a cognitive health assessment score based on an answer from the subject and the determined reaction for each of the questions.

2. The system of claim 1, wherein the physical characteristic is fine-grained movement.

3. The system of claim 1, wherein the reaction sensors are pressure sensors.

4. The system of claim 1, wherein the one or more processor-executable instructions stored on the computer-readable memory device, when executed by the processor, further cause the processor to assign a full score S^{New}ᵢ=S^{F}ᵢ for a correct answer to question Qᵢ when the determined reaction is below a predetermined threshold and to assign a low bonus score S^{New}ᵢ=μ greater than zero for an incorrect answer to question Qᵢ when the determined reaction is below a predetermined threshold.

5. The system of claim 1, wherein the one or more processor-executable instructions stored on the computer-readable memory device, when executed by the processor, further cause the processor to assign a reduced score S^{New}ᵢ={1−(f^{stress}(Qᵢ)*f^{delay}(Qᵢ))}*S^{F}ᵢ. for a correct answer to question Qᵢ when the determined reaction is above a predetermined threshold and to assign a score S^{New}ᵢ=0 for an incorrect answer to question Qᵢ when the determined reaction is above a predetermined threshold.

6. The system of claim 1, wherein the one or more processor-executable instructions stored on the computer-readable memory device, when executed by the processor, further cause the processor to correlate the determined reaction and a time delay between administration of at least one the questions and an answer to the respective question from the subject, and wherein the cognitive health assessment score assigned the subject is based on the answer from the subject, the determined reaction, and the time delay for each of the questions.

7. A method comprising:
measuring a physical characteristic of a subject during administration of a cognitive health assessment to the subject, said cognitive health assessment including a series of questions to be answered by the subject;
determining a contemporaneous reaction to each of the questions by the subject as a function of the detected physical characteristic;
measuring time delay between administration of at least one of the questions and an answer to the respective question from the subject;
correlating the determined reaction and the time delay; and
assigning a cognitive health assessment score to the subject based on the answer from the subject, the determined reaction, and the time delay for each of the questions.

8. The method of claim 7, wherein measuring the physical characteristic comprises arranging a plurality of reaction sensors on a chair on which the subject is seated during administration of the cognitive assessment for detecting the physical characteristic.

9. The method of claim 8, wherein detecting the physical characteristic comprises detecting fine-grained movement by the reaction sensors.

10. The system of claim 8, wherein the reaction sensors are pressure sensors.

11. The method of claim 7, further comprising assigning a full score S^{New}ᵢ=S^{F}ᵢ for a correct answer to question Qᵢ when the determined reaction is below a predetermined threshold and assigning a low bonus score S^{New}ᵢ=μ greater than zero for an incorrect answer to question Qᵢ when the determined reaction is below a predetermined threshold.

12. The method of claim 7, further comprising reducing the score assigned to the subject as a function of amount of both stress exhibited by the subject and the time delay in answering each of the questions.

13. The method of claim 12, wherein reducing the score comprises assigning a reduced score S^{New}ᵢ={1−(f^{stress}(Qᵢ)*f^{delay}(Qᵢ))}*S^{F}ᵢ. for a correct answer to question Qᵢ when the determined reaction is above a predetermined threshold and assigning a score S^{New}ᵢ=0 for an incorrect answer to question Qᵢ when the determined reaction is above a predetermined threshold.

14. The method of claim 7, further comprising updating the assigned score in real-time following administration of each of the questions.

15. A system comprising:
a plurality of reaction sensors for detecting a physical characteristic of a subject during administration of a cognitive health assessment to the subject, said sensors arranged on a chair on which the subject is seated during administration of the cognitive assessment for detecting the physical characteristic, said cognitive health assessment including a series of questions to be answered by the subject;
an assessment processor coupled to the sensors; and
a computer-readable memory device coupled to the processor and storing one or more processor-executable instructions thereon, said processor-executable instructions, when executed by the processor, causing the processor to determine a contemporaneous reaction corresponding to each of the questions as a function of the detected physical characteristic, wherein the subject is assigned a cognitive health assessment score based on an answer from the subject and the determined reaction for each of the questions.

16. The system of claim 15, wherein the physical characteristic is fine-grained movement.

17. The system of claim 15, wherein the reaction sensors are pressure sensors.

18. The system of claim 15, wherein the one or more processor-executable instructions stored on the computer-readable memory device, when executed by the processor, further cause the processor to assign a full score S^{New}ᵢ=S^{F}ᵢ for a correct answer to question Qᵢ when the determined reaction is below a predetermined threshold and to assign a low bonus score S^{New}ᵢ=μ greater than zero for an incorrect answer to question Qᵢ when the determined reaction is below a predetermined threshold.

19. The system of claim 15, wherein the one or more processor-executable instructions stored on the computer-readable memory device, when executed by the processor, further cause the processor to assign a reduced score S^{New}ᵢ={1−(f^{stress}(Qᵢ)*f^{delay}(Qᵢ))}*S^{F}ᵢ. for a correct answer to question Qᵢ when the determined reaction is above a predetermined threshold and to assign a score S^{New}ᵢ=0 for an incorrect answer to question Qᵢ when the determined reaction is above a predetermined threshold.

20. The system of claim 15, wherein the one or more processor-executable instructions stored on the computer-readable memory device, when executed by the processor, further cause the processor to correlate the determined reaction and a time delay between administration of at least one the questions and an answer to the respective question from the subject, and wherein the cognitive health assessment score assigned the subject is based on the answer from the subject, the determined reaction, and the time delay for each of the questions.
